(19) United States
(12) Patent Application Publication
(10) Pub. No.: US 2004/0257208 A1
(43) Pub. Date: Dec. 23, 2004

(54) Remotely controllable and configurable vehicle security system

(76) Inventors: Szuchao Huang, Redwood Shores, CA (US); Runghuang Tsai, San Mateo, CA (US)

Correspondence Address: CAPSTONE LAW GROUP LLP, 1810 GATEWAY DRIVE, SUITE 260, SAN MATEO, CA, 94404, US

(21) Appl. No.: 10/463,937

(22) Filed: Jun. 18, 2003

(51) Int. Cl. B60R 25/10

(52) U.S. Cl. 340/426.1; 340/531; 348/148

(57) ABSTRACT

A security control system for responding to security events detected by in-vehicle security systems utilizing vehicle-mounted video cameras. The system includes an in-vehicle control apparatus located within each vehicle that has a security system communications interface connected to the in-vehicle security system, memory, a controller configured to control operation of the video cameras in response to security events detected by the vehicle security system based upon configuration data and situation data, a wireless transceiver configured for bi-directional communication on a wireless link, and a communication link to the video cameras configured to transmit command data to the video cameras from the controller and receive captured images from the video cameras. Additionally, the system has a remote server in communication with the in-vehicle control apparatus of the plurality of vehicles via the wireless link, and a remote programming device in communication with the remote server via a communications network.

### FIELD OF THE INVENTION

The present invention relates to a vehicle security system that is both remotely controllable and remotely configurable, and more particularly, a vehicle security system that is integrated with a user accessible backend server and intelligent in-vehicle controller.

### BACKGROUND OF THE INVENTION

In recent years, vehicle theft and vandalism has become an increasing problem. To combat this problem, there are a wide variety of vehicle security systems available. These systems utilize motion detectors, glass breakage detectors, trunk and hood sensors, tilt sensors, power lock mechanisms, and other schemes to detect and deter thieves and vandals.

Also, more sophisticated systems are available to allow the monitoring of vehicle conditions by way of strategically located video camcorders and global positioning (GPS) tracking. Either unidirectional or bi-directional transmission channels allow for remote monitoring and response based upon conditions detected in and around the vehicle. Remote monitoring and response is effective in for both crime prevention and emergency event handling. However, current full feature systems require security personnel monitoring the images and other data received from the vehicle in real time, which is costly and impractical.

An example of such a security system is U.S. Pat. No. 5,027,104 to Reid, which discloses a vehicle security device, which includes multiple video camcorders that are activated responsive to certain conditions and are under the control of local controller mechanism. Captured video images are transmitted by the system to remote locations. However, there is no ability to control the vehicle security system from the remote locations based on the images or otherwise.

Other examples of vehicle security systems using video camcorders include the TaxiCam system by VerifEye Technologies of Ontario, Canada, and the Taxicab Security system by Sigtec of Melbourne, Australia. The images, gathered using limited view (i.e., fixed angle) video camcorders, are stored in control unit can be downloaded by cable to mobile data terminal unit or portable computer. Alternately, the systems can be configured with real time transmission of images via 2-way radio back to the control center. The systems provide for real-time video image capture and transfer to a remote location for monitoring purposes. However, there is no ability to control the vehicle security systems from the remote locations based on the images or otherwise. Moreover, costly human monitoring is required.

A system that provides control over the vehicle from a remote location based upon conditions sensed in the vehicle is U.S. Pat. No. 6,337,621 to Ogino et al. The system of Ogino coordinates between a vehicle-mounted security apparatus and an emergency response center. When a security breach or emergency condition is detected in the vehicle, the response center takes appropriate action. While this system allows for remote control over the in-vehicle security system, a costly human staffed response center is required. Additionally, there is no provision for remote configuration of the in-vehicle security system, direct user control, or video image capture.

A system that provides automated parallel and redundant subscriber contact and event notification is U.S. Pat. No. 6,442,241 to Tsumpes. The system enables automated simultaneous contact of one or more persons over a plurality of telephonic and electronic communication channels and provides parallel event-specific notification via voice, pager, fax, and email to the identified recipients(s) and a detailed message including the data and time of a specific event which has occurred with respect to a monitored sensor. The system can be triggered or programmed to perform its notification based upon the failure to receive an anticipated input and to operate at a specific time. However, there is no ability to take proper action(s) other than sending notifications. The system's main functionality is to notify the central monitoring station.

The systems described above provide a variety of in-vehicle security approaches but fail to provide a system that combines the time of event occurrence, vehicle location, and local geography information in order to process/respond to the event based on user configurable settings. In these systems, the actions taken in response to an event does not differ regardless of the time of the event, vehicle location, and local geography information.

In sum, these known methods and systems do not provide a flexible means for users to remotely interact with their vehicles in order to check the vehicle's surroundings, lock doors, dim lights, disable the ignition or the like. Moreover, most of these systems required remotely located personnel to monitor the in-vehicle security and emergency systems, which is costly. The present invention solves these problems.

### SUMMARY OF THE INVENTION

The present invention is a security control system for responding to security events detected by in-vehicle security systems utilizing vehicle-mounted video cameras. The system includes an in-vehicle control apparatus located within each of the vehicles that has a security system communications interface connected to the in-vehicle security system, a data store configured to store configuration data, a controller connected to the security system communications interface and the data store and configured to control operation of the video cameras in response to security events detected by the vehicle security system based upon configuration data, a wireless transceiver configured for bi-directional communication on a wireless link, and a communication link to the video cameras configured to transmit command data to the video cameras from the controller and receive captured images from the video cameras. Additionally, the system has a remote server in communication with the in-vehicle control apparatus of the plurality of vehicles via the wireless link, and a remote programming device in communication with the remote server via a communications network. The configuration data input at the remote programming device is transmitted via the communications network to the remote server and from the remote server via the wireless link to the in-vehicle control apparatus for storage in the data store.

The present invention has other objects and advantages which are set forth in the description of the Best Mode of Carrying Out the Invention. The features and advantages described in the specification, however, are not all inclusive, and particularly, many additional features and advantages will be apparent to one of ordinary skill in the art in view of the drawings and specification herein.

### BRIEF DESCRIPTION OF THE DRAWINGS

FIG. 1 is a block diagram of the overall system components and configuration

FIG. 2 is a flowchart depicting the in-vehicle controller handling process for in-vehicle events.

FIG. 3 is a flowchart depicting the user action preference setup.

FIG. 4 is a flowchart depicting the event parameter setup process.

FIG. 5 is a flowchart depicting the user issued in-vehicle command process.

FIG. 6 is a flowchart depicting the process of the backend server sending commands or settings to the in-vehicle control box.

FIG. 7 is a flowchart depicting the process of the user notification and response process under control of the backend server.

FIG. 8 is a flow chart depicting the process of the controller sending video images to the backend server.

### DETAILED DESCRIPTION OF THE PREFERRED EMBODIMENT

### Structure and Components

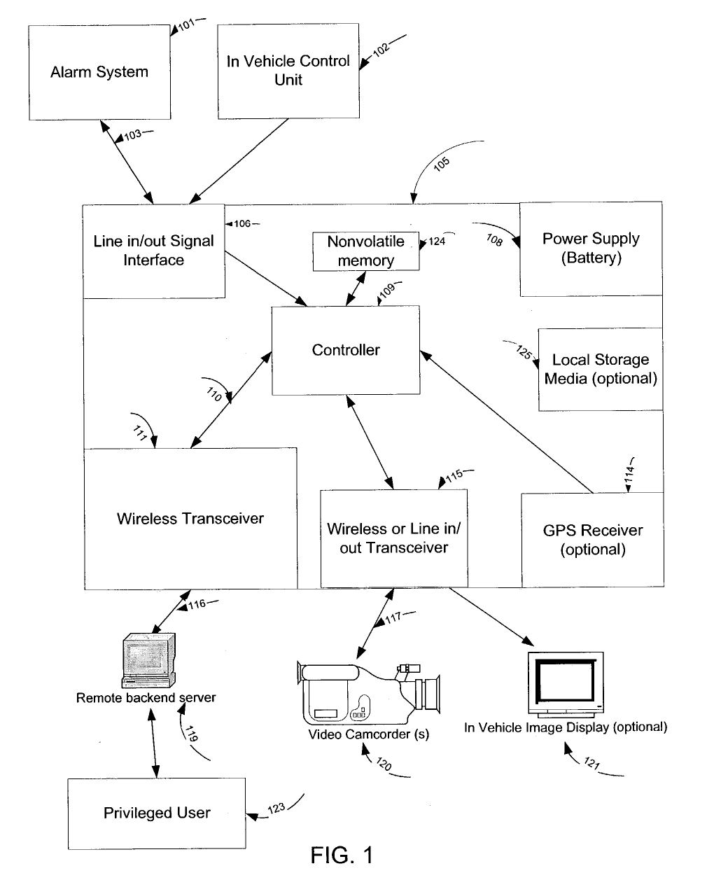

FIG. 1 depicts a block diagram of an illustrative arrangement of the present invention including in-vehicle integrated components box 105, which is coupled to alarm system 101, in-vehicle user control unit 102, vehicle mounted video camcorder(s) 120, remote backend server 119, remote user access device 123, and an optional in-vehicle video image display 121. Components box 105 includes line in signal interface 106 for receiving data signals from alarm system 101 and user control unit 102, battery 108, wireless transceiver 111 for bi-directional communications with backend server 119, transceiver 115 for bi-directional communications with video camcorders 120, and unidirectional transmission to in-vehicle display 121. All of the various components in components box 105 are coupled to and operate under the control of controller 109. Controller 109 is a standard commercial available microcontroller, such as a general-purpose microprocessor with a Linux or comparable OS. Controller 109 also includes a nonvolatile instruction memory 124 that holds a sequence of commands or steps that the controller follows.

Alarm system 101 can be any standard off the shelf vehicle alarm system for detecting motion, glass breakage, vehicle tilt, door opening, trunk opening, hood opening, and the like. In the event of an alarm being triggered, alarm system 101 emits an alarm signal on bi-directional communications line 103 that is received by line in signal interface 106. The alarm signal (which may be as simple as a power on/off signal) contains data indicative of the particular triggering alarm event (e.g., broken glass or vehicle tilting). The format of the alarm signal is manufacturer dependent. In order to present the alarm data in a format useful to controller 109, alarm signal interface 106 translates the alarm signal from the manufacturer specific format into a uniform format for processing by controller 109. Likewise, any control signals from controller 109 to alarm system 101 are translated by alarm signal interface 106 into the manufacturer specific format. Alarm signal interface 106 is pre-programmed to interface with all required manufacturer specific formats.

Additionally, interface 106 serves to process signals from user control unit 102, which is either a standard keypad or touch-screen device. User control unit 102 allows a privileged user to send commands to controller 109. A privileged user is a person (typically the vehicle owner) in possession of the required authentication information (i.e., account name and password) to the remote backend server 119. Each vehicle has its own distinct account name. The privileged user 123 can change the password.

As explained above, communication between alarm system 101 and controller 109 is bi-directional. This allows full control of alarm system 101. For example, alarm system 101 may be switched on/off by control unit 102 or by off-site privileged user via control signals sent by controller 109 to alarm system 101. Controller 109 sends the control signals based upon commands received from control unit 102 or by off-site privileged user.

Components box 105 is fully configurable by both in-vehicle control 102 and remote user device 123. Configuration options include, for example, the frequency at which video camcorders 120 capture images, the time interval at which location information from GPS receiver 114 is gathered and provided to the user. Not all the signals from the alarm system 101 will trigger the video camcorders 120 and finally results the images send to the remote backend server 119. A complete list of configuration options is described later in this specification. These configuration settings are stored in configuration tables within the nonvolatile memory 124, which map the event signals to the corresponding actions. Configuration tables may be updated by a privileged user 123 either locally using user control 102 or remotely via backend server 119. Each input event signal has a default action set, the default may be ignore, take images and transmit to remote backend server 119, emit panic sound, turn on head light to get attention, etc. The commands of the in-vehicle control unit 102 takes precedence over the commands of off-site privileged user in case of there is a command conflict. The in-vehicle control unit 102 can also be set to ignore any requests from the off-site privileged user. This is a security measure to prevent unauthorized access.

The vehicle-mounted video camcorder(s) 120 have either a multiply lens that can cover three hundreds and sixty degrees of view, or a rotating lens that can cover three hundreds and sixty degrees of view. Either of these lenses provides a full view and will not miss potentially important events, such as might occur with a partial view angle. The camcorder 120 should operate at reasonable dim light, preferably with infrared capability. The view area of the camcorder(s) 120 can be set by the user, therefore, either the interior or exterior or both views can be captured. The camcorder(s) 120 can be disabled via user control 102 as desired. The optional in-vehicle video display 121 can display the vehicle-mounted video camcorder(s) 120 in real time to the user.

Wireless transmitter 111 exchanges encrypted data or signals 116/110 between the remote backend sever 119 and the controller 109. Wireless or line-in transmitter 115 exchanges the data or signals 112/117 between vehicle-mounted video camcorder(s) 120 and the controller 109. The optional GPS receiver 114 sends the geographical information to the controller 109 for every pre-defined time interval. If the vehicle is not in the driving mode and the controller 109 detects the changes of the geographical position, this implies the unauthorized moving the vehicle. The controller 109 now can apply the preset logic to take proper actions.

Optional local storage media 125 can be used to store the images. The media could be memory, tape, or hard disks. Not all the images taken by video camcorder(s) 120 must transmitted back to the remote backend server 119, user may take images just for the scenery in the ad hoc mode and don't want to those images stored in the remote backend server 119.

Remote backend server 119 may be any standard web server or web server cluster. Server 119 is able to communicate with multiple vehicles or to handle multiple users requests simultaneously. Additionally, server 119 stores user preferences and images captured by camcorders 120 along with the associated time stamp, optional GPS information and triggered event data. Privileged users 123 can login to the server 119 via phone, web browser, PDA or other communication devices to retrieve the images and change preference settings such as notification methods, mayday event handling (airbag deployment, user triggered panic button, etc.), alarm system 101 event handling.

The notification settings indicate to whom and how server 119 provides notifications. Privilege user 123 can select one or more preferred ways to receive the notifications such as email, phone, short message service and the like, and select one or more preferred parties to receive the notifications. Each event can have different notification settings (i.e., the notification is event driven). Remote backend server 119 may be configured as fully automated system without human intervention. For example, in the event of a vehicle accident, the images and location can be forward to the law enforcement's emergency response center.

In-vehicle component box 105 and server 119 are connected via a wireless network, such as the pager, cell phone, or satellite services networks. Remote user device 123 and server 119 are connected via the Internet using standard web access protocol such as HTTP. Remote user device 123 is any type of Internet enabled appliance, such as a Internet connected personal computer, PDA, cellular telephone, or the like.

If the in-vehicle component box 105 is further integrated with the electronic control system of the vehicle, the privileged user 123 might be able to lock/unlock the doors/windows, to disable the ignition or fueling system via the remote backend server 119. This is particular useful in case the vehicle was stolen or hijacked. Another one is user accidentally leaves the key in the vehicle.

### Operation

The system depicted in FIG. 1 allows users to interact with their vehicles anywhere in the world via telephone, Internet, or other communication devices. Through backend server 119 and remote user equipment 123, users are able to remotely monitor and control their vehicle's security system.

Based upon the preference settings, the set of local maps used for navigation system can be downloaded/updated from the backend server 119 and saved in the vehicle's attached local storage 125. A new set of maps will be automatically downloaded in case of traveling close to the boundary of the existing map set. This “local intelligence” (i.e., local processing) eliminates the hassles of changing the CD/DVD maps periodically.

Remote backend server 119 can provide up-to-date information such as local traffic, weather, seasonal discount sales news, etc through a link to corresponding authorities. The information can then be transmitted to the vehicles based on the users'location.

The integration of alarm system 101 and remote backend server 119 provides for intelligent responses to alarm system 101, for example, users are automatically notified when images are taken during a pre-configured event. The pre-configured events include discovering an unauthorized entry of the vehicle, airbag deployment, or the like. The appropriate law enforcement agency can also be notified depending on the preference settings in backend server 119.

Users interact with the vehicles via backend server 119. Authorized users send command to server 119, which communicates with components box 105, to take proper actions. The two-way communication signals between server 119 and components box 105 are encrypted

Images are stored and maintained in backend server 119. This eliminates the need for components box 105 to store images in storage device 125. The digital camcorders 120 are operable for both day and night. With optional GPS information, the system may alert a user when entering high crime rate area detected by controller 109 to activate the camcorders 120 to take images at defined time interval to ensure higher security. Another example is in the event of unauthorized towing of the vehicle, the user will be notified and able to see the image in real time. The user can also have an optional configuration to send the images not only to backend servers 119, but also to an in-vehicle display to monitor the back seats. This usage is helpful for police officers when transmitting criminals, or for parents to monitor what their children are doing when seated in back.

Digital video camcorders 120 components box 105 to transmit the images wirelessly back to remote backend server 119 and to receive camcorder 120 control signals triggered by alarm system 101, airbag deployment, and in-vehicle privileged users to take real-time images for further processing to remote backend server 119. The system can also be operated by remote backend server 119 upon privileged user's request to remote control the vehicles such as taking real-time images, locking the car doors, etc. An optional GPS device can be integrated to the system to provide more information. The backend server 119 will notify privileged users or law enforcement when events (alarm triggered, airbag deployment, and etc.) occur. The notified parties and event settings are configurable by privileged users through backend server 119, which transmits the configuration data to controller 109 through wireless link 116. The privileged users 123 can communicate with backend server 119 by phone, Internet, PDA, or other devices to control in-vehicle camcorder(s) 120 remotely.

Video images are encrypted and wirelessly transmitted (through RF or wireless phone network) to remote backend server 119 in real time. This real time wireless video image transmission capability prevents tampering with the images. Even if the system or vehicle itself is destroyed, the video will be safely stored in the remote backend server 119. It also provides the users real time ability to access the video recorded anywhere in the world.

The system is fully integrated with alarm system 101 to prevent crime and vandalism. The signals of alarm system 101 are feed into the control unit of the system. If alarm system 101 is triggered, the signals are sent to the control unit. The unit uses a set of configurable predefined logics to choose the proper actions. The actions include but not limited to activating camcorders 120 to record events, sending images back to remote backend server 119 in real time, and notifying the vehicle owner.

The in-vehicle video camcorders 120 can be programmed to capture images when triggered by a Mayday signal or car accident event (such as a vehicle airbag deployed signal). Incorporation of the real time video images and GPS data improve Mayday support and speed up car accident rescue missions.

The system can be controlled by commands issued from remote backend server 119 through wireless transmitted signals. Backend server 119 can issue commands automatically based on internally stored logic. The commands issued by backend server 119 are encrypted during transmission and then are verified and decrypted by the in-vehicle control unit.

Video camcorders 120 can be triggered at the vehicle driver's will through local in-vehicle control unit 102. The video camcorder 120 trigger events are programmable. The user can re-program the camcorder 120 settings from anyplace. The privilege commands are password protected; only privilege users have ability to reprogram the trigger events. The privilege users can even control the setting of video camcorders 120 to override the commands and requests issued by remote backend server 119 to protect user privacy. However the history of these override actions will be sent back and stored in remote backend server 119.

Any video image that is sent back to remote backend server 119 or is stored in remote backend server 119 can be relayed to registered users immediately through different devices. The device could be phone, PDA, wireless phone or device with internet access capability but not limited to.

Privilege users can activate, reprogram or control the in-vehicle camcorders 120 and alarm security system remotely and in a real time manner by sending requests and commands to remote backend server 119 through Internet, wireless enabled PDA, email or phone. Backend server 119 will authenticate the users' requests then issue commands on behalf of the users to the in-vehicle camcorder 120 system and alarm system 101 via control box 105.

The system can support from one or multiple video camcorders 120. If multiple camcorders 120 are deployed, control box 105 can coordinate camcorders 120 to take video images of the are surrounding the vehicle. If only one video camcorder 120 is installed, a specialized camcorder 120, which can take three hundred and sixty degree view video images of the surroundings, is used.

The trigger events are programmable from the remote backend server 119. Thus, the logic, preference settings and features can be updated with ease at any time.

The system supports two-way communication between in-vehicle system, backend server 119 and remote users. All remote user requests and the complex logics are stored and processed in the powerful backend server 119. As a result, in-vehicle controller 109 needs relatively little computing power and memory capacity to process and store simpler logics and configuration settings. This configuration provides an intelligent and flexible integrated system with high cost efficiency.

Control box 105 includes a GPS receiver 114. Additionally control box 105 downloads crime rate data for particular locations from backend server 119 and stores the data in local storage 125 or in the nonvolatile memory of controller 109. Thus, control box 105 may provide critical decision-making functions independent of backend server 119.

Alternatively, control box 105 can send the GPS data back to remote backend server 119 when the driver parks the vehicle. If the server 119 decides the area has high crime rate by history statistics data, it could issue commands to reconfigure the settings of the system such as setting camcorders 120 to monitor surroundings of the vehicle periodically.

Events fall generally into five different categories:

1. Sensor(s) in alarm system 101.

2. The pre-specified logic or condition stored in the nonvolatile memory 124 is satisfied.

3. In-vehicle control unit 102.

4. Remote backend server 119.

5. In-vehicle integrated components control box 105.

Control box 105 can receive any event triggered by categories 1, 2, 3, or 4. Backend server 119 can receive any event triggered by categories 1, 2, 3, 4, or 5. Each event is represented by the following attributes {Source name, Intensity, Time, Location, Extended data}.

Operable components can recieve and execute commands issued by controller 109. The following are some examples of operable components:

| Operable component | Operation |
|---|---|
| Power Door lock | Lock/Unlock/Set configure |
| Power Windows | Roll up/Roll down/Set configure |
| Alarm Siren | Chirp/Full scale/Set configure |
| Horn | Honk/Set configure |
| Interior Light | Turn on/Turn off/Set configure |
| Ignition Starter | Turn on/Turn off/Set configure |
| Head Light | Turn on/Turn off/Set configure |
| Trunk | Lock/Unlock/Set configure |
| Digital Camcorder | Turn on/Turn off/Stand by/Take |
| | image/Set configure |
| GPS | Get location data/Set configure |
| Car Immobilizer | Arm/Disarm/Set configure |

Each operable component has the following attributes stored in nonvolatile memory 124: {Component name, Support operations, Current state, Last applied operation, Time of last applied operation, Remote command allowed, Extended data}.

Operation is a command sent to controller 109 to invoke an operable component. The operation comprises the following attributes:

{Target component name, Issuer, Operation, Frequency, Start time, End time, Intensity, Extended data}; however, not every attribute is required for different operations. For example:

Attributes for Door Lock Operation

| Attribute Name | Attribute Value |
|---|---|
| Target component name | Front door on the driver side |
| Issuer | Controller |
| Operation | Lock |
| Frequency | N/A |
| Start time | Immediately |
| End time | N/A |
| Intensity | N/A |
| Extended data | N/A |

Attributes of Camcorder 120 Operation

| Attribute Name | Attribute Value |
|---|---|
| Target component name | Digital Camcorder |
| Issuer | Backend Server, Rung Tsai |
| Operation | Take image |
| Frequency | 10 frames/sec |
| Start time | Apr. 20, 2003 12:03:20 |
| End time | Apr. 20, 2003 12:45:30 |
| Intensity | Strongest |
| Extended data | N/A |

Attributes of Alarm Siren Operation

| Attribute Name | Attribute Value |
|---|---|
| Target component name | Alarm siren |
| Issuer | Controller |
| Operation | Turn on |
| Frequency | N/A |
| Start time | Apr. 20, 2003 18:40:30 |
| End time | Apr. 20, 2003 18:45:30 |
| Intensity | Strongest |
| Extended data | N/A |

When control box 105 processes detect abnormal conditions, it takes two additional factors, time and location, into consideration. Hence, the same type of events may not be dealt with the same way if the time and location of the event are different. For example, the event of the impact sensor detecting a medium impact hit on the vehicle. An event like this could be sent to controller 109 as: {Source name: Impact sensor, Intensity: medium, Time: Apr. 28, 2003 23:35:48, Location: GPS data, Extended data: N/A}. Controller 109 gets the crime rate of the location pre-stored in local storage 125, and then evaluates the crime rate of this location and time of the event detected to decide the proper action. For this event, if the location has high crime rate and the time of the event happening is close to midnight, controller 109 activates camcorder 120 and sends the captured images to backend server 119. Backend server 119 then notifies the user. The user can login to backend server 119 to watch the real time images and take the appropriate action. Time and location are used as the “contribution factors” to the vehicle security systems.

However if the same event happens but controller 109 determines the vehicle is in a very safe location, then the system will not disturb user for the event, which may be caused by neighbor's cat jumping on the vehicle.

The intelligent controller 109 can download the crime rate of the local area from the backend server 119 to local storage 125. An exemplary event trigger condition is as follows: if the vehicle is moving in a high crime rate area then an event {Source name: Controller, Intensity: high, Time: current time, Location: GPS data, Extend data: N/A} will be issued by the controller 109. Controller 109 determines the necessary action to be taken. The action could be that the controller 109 checks the vehicle condition and sends a warning to the driver. For example, when an event is triggered, controller 109 could warn the driver and roll up the windows automatically. Controller 109 automatically downloads the crime rate data periodically as the vehicle traveling in different areas.

Another usage is that parent can set the “out of area event” and get notified when their children drive out of a certain area. The area here is a region defined by the parent, i.e., privileged user. The area data is stored in both backend server 119 and in-vehicle memory (either nonvolatile memory 124 or local storage 125). Controller 109 can check if the vehicle is in the area without contacting backend server 119 to reduce the frequency of communicating with backend server 119.

A further integration with intelligent home technology is possible. For example, when the vehicle is close to home then backend server 119 can send preset commands to activate home appliances (i.e. air conditioner/light/garage door) if the intelligent home management software is integrated with backend server 119.

When a predefined car accident event occurs, such as air bag deployed signal or user activated Mayday signal, event data is provided to controller 109. Taking the air bag deployed event as an example, the following event attributes are sent to controller 109: {Source name: Air bag deploy, Intensity: high, Time: current time, Location: GPS data, Extend data: N/A}. Controller 109 checks the event/action table and takes the corresponding action for the event. If the user does not redefine new action for the car accident event, then the default action will be taken: controller 109 activates video camcorders 120, which immediately records video images continuously and transmits encrypted (video image data and the car accident event) back to remote server 119 in real time. When backend server 119 receives the car accident event, it checks the event/action table and takes the corresponding action for the event. The default action for the car accident event may include notifying the nearest emergency rescue team and providing the real time video images to them to indicate the needed equipment and trained medical staff, notifying local police, and notifying the emergency contact persons appointed by the user.

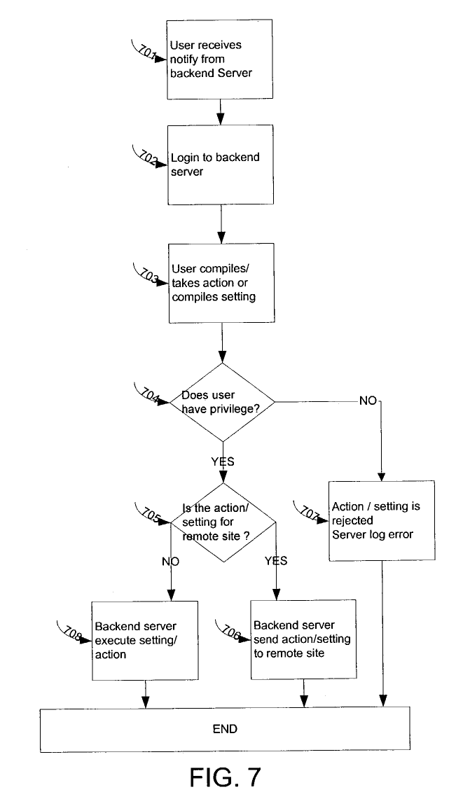

Upon receiving event notification, user can also receive real time images from backend server 119 on devices such as a PDA via secure network. The user can also login to backend server 119 to watch real time video images and send operations to the vehicle to respond to the event (see FIG. 7). Referring to the above example:

1. The impact sensor detects medium impact in a high crime rate area and user receives notification from backend server 119 (Step 701).

2. User logs in to backend server 119 through Internet (Step 702).

3. User can take action to watch real time video image sent back from in-vehicle camcorder 120 (Step 703).

4. Backend server 119 checks if user has privilege to review the video image (Step 704). If user does not have proper privilege to watch video image, then backend server 119 rejects the user's request and logs the rejected request (Step 707). This watch operation is local to backend server 119.

5. Server executes the operation for the user (Step 708). Or

6. The user can also send operation commands to remotely control in-vehicle video camcorder 120. After the user views the video image, he can turn off the siren if desired by recompiling the siren operation.

7. Backend server 119 checks if the user has the privilege to execute the operation (Step 704). If user does not have privilege, the request is rejected.

8. Backend server 119 checks if the operation is for the remote system (Step 705). Since the siren turn off operation is a remote operation, the server 119 encrypts and sends the operation to in-vehicle system to turn it off (Step 706).

9. Controller 109 receives and decrypts the encrypted signal from server 119 (Step 602).

10. Controller 109 checks if the signals are from an authenticated server 119 (Step 603). If the signals are not from authenticated server 119 then the controller 109 logs “not authenticated server 119” error and disconnects (Step 607). If the controller 109 verifies the signals then the controller 109 checks if the siren accepts remote control (Step 604).

11. If the remote operation is allowed, then the controller 109 interprets the operation and sends proper signal to siren to turn off the alarm siren (Step 605).

12. After the siren is turn off, the controller 109 reports the result back to backend server 119 (Step 606).

If the user does not receive the notification from backend server 119 in time, backend server 119 or controller 109 have the following logic: “if user does not respond within a certain time, then it can take preset action X”. The action X will be taken by backend server 119 or by controller 109 to response to the situation without user intervention. When the user gets chance to login to server 119, the user can check the real time image by controlling the in-vehicle camcorder 120 remotely. The user can issue the following operation command: {Target component name: Digital Camcorder, Issuer: “Backend Server, Rung Tsai”, Operation: Take image, Frequency: 10 frames/sec, Start time: Apr. 29, 2003 01:35:48, End time: Apr. 29, 2003 01:45:00, Intensity: N/A, Extended data: “Encrypt: Public key, Storage: Backend Server”}. Backend server 119 encrypts the operation command and sends it to controller 109. Controller 109 receives and decrypts the encrypted signal from server 119 (Step 602). Controller 109 checks if the signals are from an authenticated server 119 (Step 603). After controller 109 verifies that the signals do come from authenticated server 119, controller 109 checks if camcorder 120 accepts remote control (Step 604). If the remote operation is allowed, then controller 109 interprets the operation command and sends proper signal to operate camcorder 120 (Step 605). After camcorder 120 is activated, the controller 109 receives real time images from camcorder 120 through wireless transmitter 115 (Step 802). The controller 109 checks if the encrypt option is set in the operation command (Step 803). The encrypt option is set to “public key” in the extended data field of the command. It tells controller 109 to use the public key encryption algorithm to encrypt the images (Step 804). This provides privacy for the user. The images will be encrypted with the public key of the user. Only user who holds the private key is able to decrypt the images. Even backend server 119 is unable to decrypt user images. The communication between in-vehicle system and backend server 119 is always encrypted.

Controller 109 then checks if it needs send images to backend server 119 (Step 805). The extended data attribute of the operation is set to “Storage: Backend Server”. It directs controller 109 to send back images to backend server 119. Controller 109 encrypts the triggered event and time and location data, and sends the encrypted data to backend server 119 (Step 806). Since the images have been encrypted with the users public key, the controller 109 does not need to encrypt the images again.

It is a powerful capability to allow off-site user and backend server 119 control the in-vehicle system remotely. However, this remote control ability raises great concern over user privacy. It is an important feature allowing the privileged user to set the in-vehicle system to reject the commands issued from remote backend server 119 or through in vehicle control unit 102. This override request will be sent back to remote backend server 119 and logged in backend server 119. For example, the privileged user can issue a command to set video camcorder 120 to reject the remote command issued by backend server 119 (Step 503). The command is {Target component: Camcorder, Issuer: “In-vehicle control unit, Rung Tsai”, Operation: Set configure, Frequency: N/A, Start time: N/A, End time: N/A, Intensity: N/A, Extended data: “Remote command allowed: No”}. Controller 109 checks if the user has privilege to issue the command (Step 504). If the user has proper privilege the controller 109 executes the command to set camcorder component 120 to reject any remote operation (Step 505). Controller 109 will send all of component setting change activities back to backend server 119 (Step 508).

A hand-held device carried by the user may be employed to let in-vehicle digital camcorder 120 track the user. The purpose of this device is to let camcorder 120 know where to capture images. When a user parks his car he can carry the device. The device activates camcorder 120 and adjusts focus to follow the user home. The image taken can be sent back to remote server 119 immediately.

### Server and In Vehicle Processes

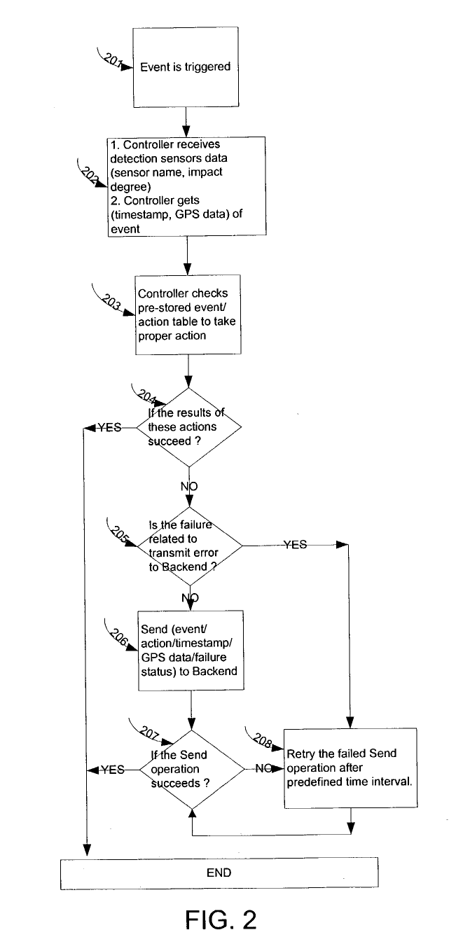

FIG. 2 is a flowchart depicting the process of how in-vehicle controller 109 handles triggered in-vehicle events. When alarm system 101 sensors detect an abnormal condition occurring in the vehicle, a pre-defined condition in controller 109 being satisfied or a user notification issued by in-vehicle control unit 102, an event is triggered (step 201). The signals go through the line in/out signal interface 106 and are sent to controller 109. Controller 109 determines the attribute values of the triggered event such as names and impact degrees (intensity) of the abnormal-condition-detected sensors. At the same time, controller 109 gets timestamp and location data for the event from the controller's timer and GPS device 114 (step 202). Controller 109 checks the predefined event-action table stored in nonvolatile memory to see if the event has a correspondent action. If there is a correspondent predefined action for the triggered event, controller 109 executes the action. Otherwise controller 109 executes the default action in response to the triggered event (Step 203). To execute the action, controller 109 sends signals through line in/out signal interface 106 to involved components of alarm system 101 and through wireless in/out transmitter 115 to video camcorders 120 if camcorder 120 operation is involved. The action may require the transmission of status or image data to backend server 119. Controller 109 sends signals via wireless transceiver 111 to remote backend server 119. After the action is complete, controller 109 checks whether the action succeeds or fails (Step 204). If any operation of the action fails, then controller 109 verifies whether the failure involve data transmission errors between control box 105 and backend server 119 (Step 205). If the failure has nothing to do with data transmission then controller 109 sends the triggered event, the action taken and failed operations to backend server 119 (Step 206). Controller 109 again checks if step 206 succeeds (Step 207). If step 206 fails, then controller 109 executes a retry procedure (Step 208). If the failure involves data transmission problems between remote backend server 119 and control box 105, controller 109 will execute a retry procedure (Step 208). In the retry procedure, controller 109 logs problems and retransmits data in a predefined time interval. After the retry, controller 109 checks if the retry succeeds (Step 207).

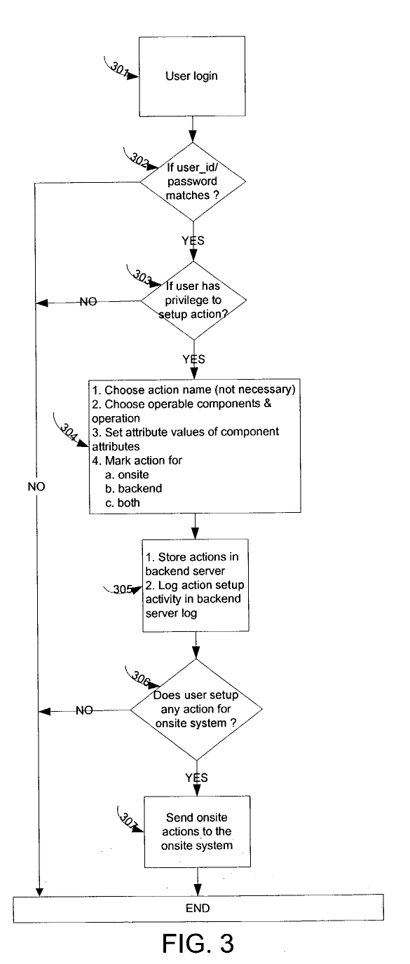

FIG. 3 is a flowchart depicting the user preference setup process for control box 105 and backend server 119. A user logs in to remote backend server 119 (Step 301). Backend server 119 checks if the user name and password are correct (Step 302). If the user name and password are not correct, the backend server 119 rejects the user login. If the user name and password are correct, server 119 checks the user privilege to see if the user has the proper privilege to setup actions (Step 303). If the user does not have the proper privilege, then the request is rejected. If the user has privilege to setup actions, then the user is allowed to start the process for action setup (Step 304). In the action setup process, the first step is that user can choose the name of the action he is setting up to uniquely identify the action. However it is not necessary for the user to name every action he creates. If the name of the action is not specified then backend server 119 creates a unique action name for the user automatically. The second step is that the user decides what operations the action is composed of. The action can be a single operation or a set of operations. Then the user must decide if the action is for control box 105, backend server 119, or both. Once the user completes the action setup, backend server 119 validates the actions and stores them in backend server 119. Backend server 119 also logs the action setup activity of the user in backend server 119 log (Step 305). Backend server 119 checks if there is any action for control box 105 (Step 306). If all the actions are for backend server 119, then user completes the action setup process. If there is any action for control box 105, then backend server 119 encrypts and sends these actions data to control box 105 and updates controller 109 (Step 307).

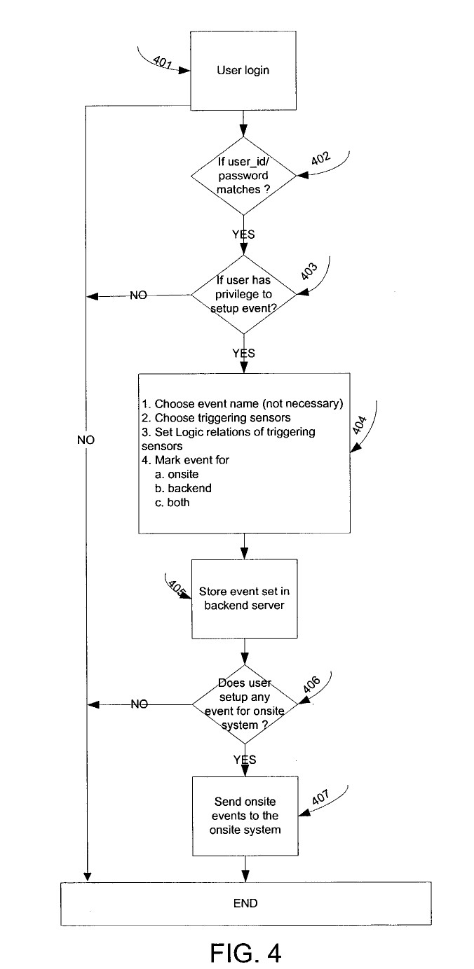

FIG. 4 is a flowchart depicting the event parameter setup process for control box 105 and backend server 119. A user logs in to remote backend server 119 (Step 401). The backend server 119 checks if the user name and password are correct (Step 402). If the user name and password are not correct, backend server 119 rejects the login. If the user name and password are correct, server 119 checks the user privilege to see if the user has the proper privilege to setup event (Step 403). If the user does not have the proper privilege then request is rejected. If the login user has privilege then user can start the process for event set setup (Step 404). In the process of the event set setup, the first step is that user can choose the unique name of the event set (Step 404.1). It is not necessary for user to name every event set user creates. If the name of event set is not specified then the backend server 119 can create a unique event set name for user automatically. The next step is to choose the sensor(s) corresponding to the event set (Step 404.2). An event set can relate to one or multiple sensors, user can set the logical relation (i.e. AND, OR) among the participated sensor(s) in the event set (Step 404.3). For example, an event set maybe defined as “1. Sensor A is on, or 2. Sensor B and sensor C are both on”. Then the user chooses if the action is for control box 105, backend server 119, or even both (Step 404.4). Backend server 119 validates the event set and stores it in backend server 119 (Step 405). Backend server 119 checks if there is any event set for the in-vehicle system (Step 406). If all the actions are for backend server 119, then the user completes the action setup process. If there is any action for control box 105, then backend server 119 encrypts and sends the actions data to control box 105 and updates controller 109 (Step 407).

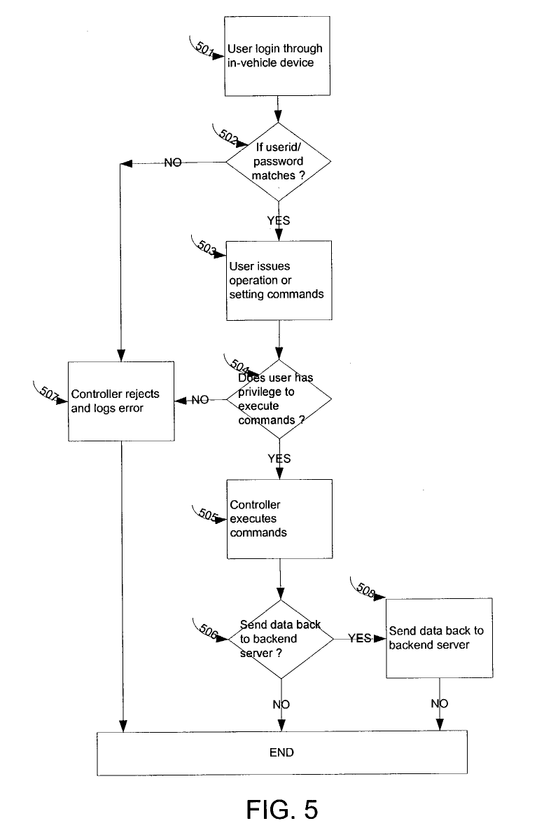

FIG. 5 is a flowchart depicting the process of the user issuing an in-vehicle command. Users enter login name and password though in-vehicle control device 102 (Step 501). Controller 109 checks if the user name and password match (Step 502). If the password is not correct then the controller 109 rejects the login request and logs the errors (Step 507). If the login name and password of the user are correct, then the user is permitted to issue commands to operate components or change local settings (Step 503). The commands are sent to controller 109 through Line in/out signal interface 106. Controller 109 checks if the user has the privilege to issue the command (Step 504). If the user does not have proper privilege to issue the command, then controller 109 rejects the commands and logs the error (Step 507). If the user has proper privilege for the command, then controller 109 will execute the command (Step 505). Controller 109 checks if the issued commands need to send data to backend server 119 (Step 506). If it is necessary to send data to backend server 119, controller 109 encrypts and sends the data to backend server 119 (Step 508).

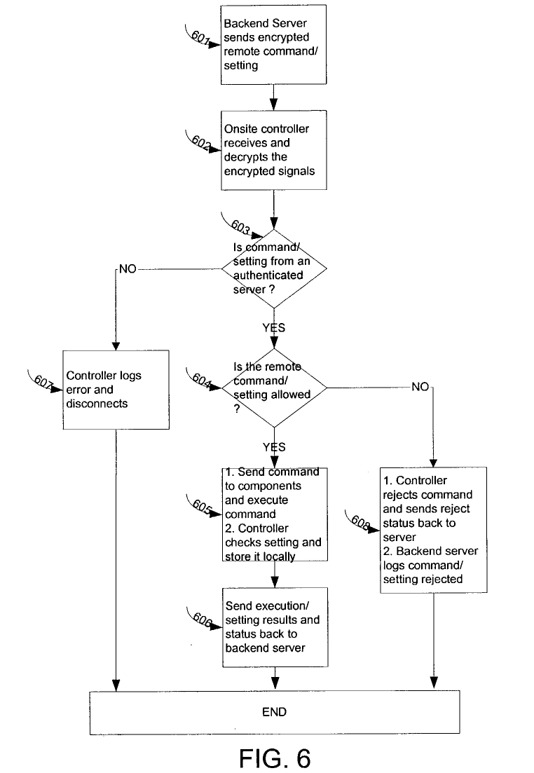

FIG. 6 is a flowchart depicting the process of the backend server 119 sending commands or settings to control box 105. Backend server 119 encrypts the commands or settings, and then sends the data to control box 105 (Step 601). Controller 109 receives signals from wireless transceiver 111. Controller 109 then decrypts the encrypted signals (Step 602). Then, controller 109 checks if the data was sent by an authenticated remote server 119 (Step 603). If the data is not from an authenticated source, then controller 109 rejects the data and disconnects the connection. Controller 109 logs the error and informs remote backend server 119 of the unauthenticated connection attempt (Step 607). If the connection is coming from an authenticated source, then controller 109 checks if the remote command or setting is allowed (Step 604). If the remote command or setting option is set to disable, then controller 109 rejects the commands or setting requests issued from backend server 119 and informs server 119 the reason for the rejection. Remote backend server 119 receives the rejection from controller 109 and logs the event (Step 608). If remote commands and settings are allowed, for commands controller 109 checks the targeted component if the operation is legal. If the remote commands are allowed, then controller 109 sends operation commands to the target component for execution (Step 605.1). For settings, controller 109 stores them in nonvolatile memory 124 or local storage 125 after controller 109 validates the settings (Step 605.2).

FIG. 7 is a flowchart depicting the process of the user notification and response process under control of backend server 119. When the user receives a notification from backend server 119 (Step 701), the user may decide to take actions such as watching the video images taken by the system, sending operation commands to control box 105 or changing the settings of control box 105. The user receiving the notification can login to backend server 119 by phone or through Internet (Step 702). After backend server 119 verifies the login name and password of the user, the user can take actions to respond to the notification. The actions could be watching video images sent from camcorder 120, changing settings of backend server 119 or control box 105, or any combination of those. The user can compile the actions he wants to take for the event (Step 703). Backend server 119 will verify if the user has proper privilege for executing these actions (Step 704). Backend server 119 will reject the actions and log the rejected actions for the record if the user does not have privilege for these actions (Step 707). If the user has privilege for the actions, server 119 will check if there is any action or setting for control box 105 (Step 705). If all of the actions issued by the user are for backend server 119 only, then backend server 119 executes these actions (Step 708). If there are actions or settings for control box 105, then backend server 119 will send these user actions or settings to control box 105 on behalf of the user (Step 706).

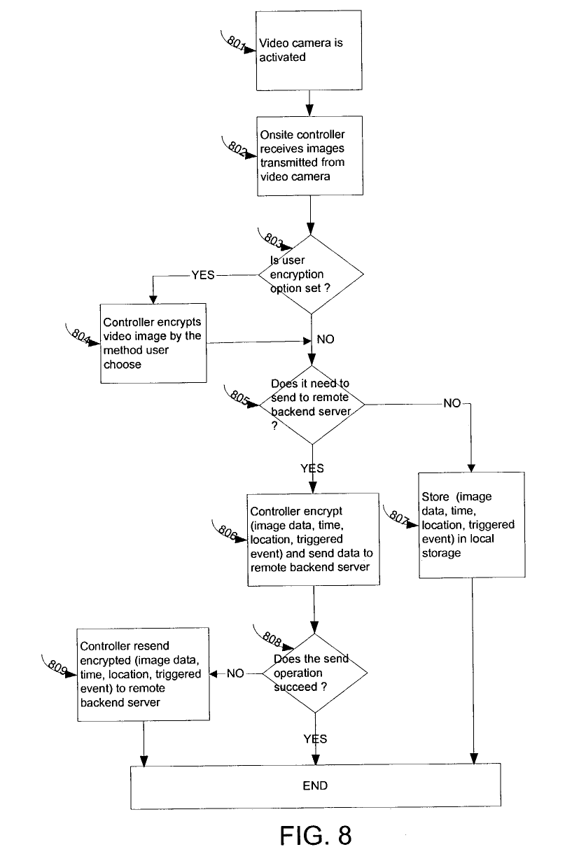

FIG. 8 is a flow chart depicting the process of the controller 109 sending video images to backend server 119. Video camcorder 120 receives operation commands issued by controller 109 on behalf of remote backend server 119, controller 109 itself, or the user using control unit 102 in the vehicle (Step 801). Video camcorder 120 is operating and sending image data through wireless line in/out transceiver 115 to controller 109 (Step 802). The controller 109 first checks if the encryption option is set by the user (Step 803). If the user encrypt option is on, then controller 109 encrypts the image data using the pre-specified encryption algorithm (Step 804). Otherwise, controller 109 will not encrypt image data at this moment. Controller 109 checks if the image data needs to be sent back to remote backend server 119 (Step 805). If video camcorder component 120 is set to not remotely store data, then the image data will be stored in local storage 125 (Step 807). If the image data needs to be sent to backend server 119, controller 109 encrypts the image data and triggered event data, and sends the encrypted data to backend server 119 (Step 806). The communication between controller 109 and backend server 119 is always encrypted. But for the better privacy protection, the user can even set the parameters to encrypt the image data using a special encryption algorithm such as public key/private key protection, so that only the user can watch the image. In this form, backend server 119 cannot access the user's image data.

From the above description, it will be apparent that the invention disclosed herein provides a novel and advantageous vehicle security system that is both remotely controllable and remotely configurable. The foregoing discussion discloses and describes merely exemplary methods and embodiments of the present invention. One skilled in the art will readily recognize from such discussion that various changes, modifications and variations may be made therein without departing from the spirit and scope of the invention.

We claim:

1. A security control system for responding to security events detected by in-vehicle security systems located within a plurality of vehicles having vehicle-mounted video cameras comprising:
an in-vehicle control apparatus located within each of the vehicles comprising:
a security system communications interface connected to the in-vehicle security system;
a data store configured to store configuration data;
a controller connected to the security system communications interface and the memory and configured to control operation of the video cameras in response to security events detected by the vehicle security system based upon configuration data and situation data;
a wireless transceiver configured for bi-directional communication on a wireless link;
a communication link to the video cameras configured to transmit command data to the video cameras from the controller and receive captured images from the video cameras;
a remote server in communication with the in-vehicle control apparatus of the plurality of vehicles via the wireless link; and
a remote programming device in communication with the remote server via a communications network, the remote programming device being configured for the input of the configuration data;
wherein the configuration data input at the remote programming device is transmitted via the communications network to the remote server and from the remote server via the wireless link to the in-vehicle control apparatus for storage in the data store.

2. The system recited in claim 1, wherein the captured images are transmitted to remote server via the wireless communications link.

3. The system recited in claim 1, further comprising a data entry device located within the vehicle and coupled to the in-vehicle control apparatus and configured for the input of the configuration data.

4. The system recited in claim 1, wherein the remote server is configured to authenticate the remote programming device through a secure login procedure.

5. The system recited in claim 1, wherein the situation data includes vehicle location data, local geography data and time of day data.

6. The system recited in claim 5, wherein the vehicle location data is provided by a global positioning system.

7. The system recited in claim 1, wherein in response to detection of a security event by the in-vehicle security system, the in-vehicle control apparatus transmits event data comprising data indicative of the security event, a time stamp, and the captured images to the remote server.

8. The system recited in claim 1, wherein in response to detection of a security event by the in-vehicle security system, the in-vehicle control apparatus is configured to transmit data indicative of the security event to the remote server, and wherein the remote server is configured to compare the security event data to a set of pre-defined response criteria and based upon the comparison to provide a notification of the security event to the remote programming device.

9. A remotely configurable in-vehicle control apparatus for responding to security events detected by an in-vehicle security system located within a vehicle having vehicle-mounted video cameras and for communicating with a remote server via a wireless link and a remote programming device configured for input of configuration data and coupled to the remote server via a communications network comprising:
a security system communications interface connected to the in-vehicle security system;
a data store configured to store configuration data;
a controller connected to the security system communications interface and the data store and configured to control operation of the video cameras in response to security events detected by the vehicle security system based upon configuration data;
a wireless transceiver configured for bi-directional communication on the wireless link;
a communication link to the video cameras configured to transmit command data to the video cameras from the controller and receive captured images from the video cameras;
wherein the configuration data input at the remote programming device is transmitted via the communications network to the remote server and from the remote server via the wireless link to the in-vehicle control apparatus for storage in the data store.

10. The apparatus recited in claim 9, wherein the captured images are transmitted to remote server via the wireless communications link.

11. The apparatus recited in claim 9, wherein the situation data includes vehicle location data, local geography data and time of day data.

12. The apparatus recited in claim 11, wherein the vehicle location data is provided by a global positioning system.

13. The apparatus recited in claim 9, wherein in response to detection of a security event by the in-vehicle security system, the in-vehicle control apparatus transmits event data comprising data indicative of the security event, a time stamp, and the captured images to the remote server.

14. The apparatus recited in claim 9, wherein in response to detection of a security event by the in-vehicle security system, the in-vehicle control apparatus is configured to transmit data indicative of the security event to the remote server, and wherein the remote server is configured to compare the security event data to a set of pre-defined response criteria and based upon the comparison to provide a notification of the security event to the remote programming device.
